(19) United States
(12) Patent Application Publication
(10) Pub. No.: US 2023/0141626 A1
(43) Pub. Date: May 11, 2023

(54) MULTIPOSITION FIXTURE HOLDER

(71) Applicant: Omnifixo AB, Gustavsberg (SE)

(72) Inventor: Johann ZITA, Gustavsberg (SE)

(21) Appl. No.: 17/911,798

(22) PCT Filed: Mar. 19, 2021
(86) PCT No.: PCT/SE2021/050244

§ 371 Date: Sep. 15, 2022

(30) Foreign Application Priority Data
Mar. 19, 2020 (SE) 2050300-9

(51) Int. Cl. B25B 5/00; F16M 11/04; F16M 11/14; F16M 13/02

(52) U.S. Cl. CPC B25B 5/006; F16M 11/041; F16M 11/14; F16M 13/022

(57) ABSTRACT

An arrangement including a fixture device that includes a holding device, a ball, a socket and a magnet. The holding device includes first and second holding elements and a biasing member arranged to force at least one of the two holding elements into a holding position. The ball is attached to the holding device. The socket includes a first side configured to receive at least part of the ball. A section of the ball is made of a magnetic material such that the ball is maintained in a selected position in relation to the socket by the magnet. A support includes a magnetic material wherein the fixture device is arranged to be removably attached to the support by a magnetic force and wherein the socket includes a second side attached to the support by the magnet and wherein the socket is movable along the surface of the support.

### FIELD OF THE INVENTION

The present invention generally relates to the field of holding devices for holding components more particularly to devices for improving the support of components, such as workpieces.

### BACKGROUND OF THE INVENTION

When performing work involving for example small electrical components, jewelry or similar components, there may be high demand for precision when for example adhering components by for example gluing or soldering. This may be achieved by utilizing holders, fixtures or clamps to stabilize the component(s) in order to facilitate the work performed on or with the component(s).

For example, during soldering both solder material and heat may have to be applied onto a surface and preferably the component(s) are then kept in a fixed position while applying the solder and heat. In order to achieve this holders, fixtures or clamps may be used to fixate the component(s) while performing the necessary work on or with the component(s).

In patent publication U.S. Pat. No. 4,070,011A a jig for holding workpieces is disclosed including several arms joined at a common center, and each arm also comprises a self-biasing closure member. However, at least one drawback of the disclosed solution is that the threaded wing nut or thumb screw used to hold the joint together often is subjected to wear affecting the need of constantly adjusting the threaded wing nut or thumb screw.

Another solution for holding devices is disclosed in patent publication U.S. Pat. No. 2,887,974A. The device shown has flexible arms with clips for holding articles. However, at least on drawback of this device is that adjustments with the flexible arms are somewhat inaccurate due to a built-in elasticity property of the arms. Hence, it may be difficult to have the arms remain in a desired position. Additionally, the arms are subject to wear when adjusting the respective arm position.

US20180050407A1 discloses a similar solution, using a flexible arm, with similar drawbacks to that of the flexible arm in U.S. Pat. No. 2,887,974. The above identified prior art has an additional common drawback of using a standard type clip, also known as crocodile clip, where openable jaws holds components and where the clip may rely on friction from jagged teeth of the jaws to attract to the surface of the component held by the clip. Objects may, when for example being too big, risk losing friction to the clip and unwantedly be released by the clip. This may in turn damage the component by for example scratching the surface whilst the components slip of the jaws of the clip.

### SUMMARY OF THE INVENTION

It would be advantageous to achieve a device for holding components overcoming, or at least alleviating, the above mentioned drawbacks. In particular, it would be desirable to enable facilitated movement of a fixture device with improved holding and/or fixating properties. To better address one or more of these concerns, a fixture device having the features defined in the independent claim is provided. Preferable embodiments are defined in the dependent claims.

Hence, according to an aspect, an arrangement is provided comprising a fixture device for removably holding components. Said fixture device may comprise a holding device intended to removably hold components. The holding device may comprise a first and a second holding element and a biasing member arranged to force the two holding elements into a holding position. The fixture device may further comprise a ball attached to the holding device and a socket comprising a first side configured to receive at least part of the ball such that the ball can slide in relation to the socket. The socket may further comprise a magnet. Wherein at least a section of the ball may be made of a magnetic material such that the ball is maintained in a selected position in relation to the socket by the magnet. The arrangement further comprising a support comprising a magnetic material wherein the fixture device is arranged to be removably attached to the support by a magnetic force. The socket comprises a second side attached to the support by said magnet and wherein said socket is movable along the surface of the support.

By removably hold or removably holding it may be meant hold or holding by an applied force. When said applied force is decreased the removal of the components held by the holding device may be facilitated. In other words, by the holding device being intended to removably hold or holding components it may be meant that the holding device is intended to hold components by an applied force.

By forcing the two holding elements into a holding position it may be meant that the two holding elements are forced into a position where the two holding elements experience a counter force acting on the holding elements in an opposite direction compared to that of the applied force. In other words, by forcing the two holding elements into a holding position it may be meant that the two holding elements are forced into contact with each other or forced together such that the two holding elements are brought into contact with an item arranged between the two holding elements. By an item it may be meant an item and/or component for the device to hold. By an item and/or component for the device to hold it may be meant an intermediately positioned component between the two holding elements. Hence, by the holding position it may be meant the position wherein the two holding elements are brought into contact with each other or brought in contact with an item when in use. Wherein the item may be a component being removably held by the holding device.

In other words, by forcing the two holding elements into a holding position it may be meant that the biasing member is arranged to force the two holding elements into a holding position wherein holding elements are arranged to removably hold the components under operation.

In other words, the holding device may be arranged to removably hold components when in said holding position.

By when in use or under operation, it may be meant under the typical circumstance wherein the device is meant to be used. Hence, for example, the component held by said holding device is not in itself important for the present invention.

By a biasing member it may be meant a member storing mechanical energy. By a biasing member it may be meant at least one of a helical spring, a coil spring, a torsion spring, a helical torsion spring, a mainspring and any other biasing member arranged to store mechanical energy.

By fastening the fixture device to a support by the magnet it may be meant that the fixture device may be attached to a support by a magnet, wherein the support may be at least one of a surface, a base, a basis, and any surface or fixture suitable to attach the fixture device to by the magnet.

By a selected position it may be meant a position of the fixture device when the fixture device is in use. It may be meant a position of at least one of the ball, the first and second holding device selected when the fixture device is in use. In other words, by a selected position it may be meant a selected position of the holding device when the holding device is in use. By a selected position it may be meant a selected position of the ball when the device is in use. Hence, by the ball is maintained in a selected position it may be meant that the position of the ball is changeable, and that a position may be selected and maintained. In other words, a position of the ball may be selectable and maintainable. By the position of the ball is changeable it may be meant that the position of the ball within the socket may be changeable according to a 3-axis articulation. By a 3-axis articulation it may be meant rotation about three axes' being perpendicular to each other. In other words, it may be meant that the ball may be moved freely within the socket. Further, by the ball is maintained in a selected position in relation to the socket by the magnet it may be meant that a friction force between the ball and the socket is achieved by the magnetic force attracting the ball to the socket. In other words, the ball may be maintained in a selected position in relation to the socket by a force of friction achieved by the magnet. The movement of the ball within the socket may be limited to the position of at least one of the holding device and a device connecting the holding device to the ball. Hence, by the ball being able to move freely it may be meant a free movement limited by the position of the position of at least one of the holding device and a device connecting the holding device to the ball.

Generally, this may provide in a facilitated holding and/or fixation of components in a desired position and/or orientation since the fixture device may be rotated freely.

The holding device may facilitate the holding of components since the holding elements are forced into a holding position. The biasing member may further facilitate the holding of components by the force it applies to the holding elements may be adapted to the components to be removably held by the holding device.

The ball and socket may facilitate selecting a desired orientation of the fixture device when the fixture device is in use since the ball and socket may enable movement of the fixture device according to a 3-axis articulation. This may further facilitate the work to be performed on the components since components may be held by the holding device when the holding device is in use. Additionally, the ball and socket may facilitate positioning and/or orientation of the ball and/or the holding device relative the socket without suffering from any elasticity and/or hysteresis of parts connecting the holding device to for example a support. In other words, a facilitated orientation and/or movement of the ball and/or the holding device may be provided where the ball and/or the holding device may have a non-elastic positioning relative the socket, i.e. not changing the orientation and/or position after a position of the ball within the socket has been selected. By a non-elastic positioning it may be meant a position with substantially no elasticity when positioning, i.e. the ball and socket may stay in a desired position and not have built in stress, forcing parts into a previous position.

The magnet may provide the combination of a facilitated reception of the ball by the socket and a facilitated attachment of the socket to a support. Hence, the magnet may provide the fixture device to be removably attached to both the socket and/or a support.

The first side may facilitate the free relative movement of the ball in relation to the socket.

The ball may facilitate the movement of the ball in relation to the socket to be a free movement, in other words, the ball may facilitate free movement of the ball in relation to the socket.

The combination of the socket comprising a magnet and that at least a section of the ball being made of a magnetic material may facilitate the reception of the ball by the socket by the magnet. This may also provide the ball, and hence the holding device, to be removably attached to the socket. Additionally, the combination of the socket comprising a magnet and that at least a section of the ball being made of a magnetic material may facilitate a solution being less susceptible to wear. This, since the ball may still be attached to the socket by the magnetic force from the magnet even if, for example, the magnet and/or socket may get worn down by the ball and socket repeatedly interacting over time.

Further, by attaching the fixture device onto a support comprising a magnetic material may further provide a facilitated holding and/or fixation of components in a desired position and/or orientation since the fixture device may be rotated freely and attached to a support. Since, the at least one fixture device is arranged to be removably attached to the support by a magnetic force this may further facilitate the holding and/or fixation of components in a desired position and/or orientation since the fixture device is removably attached. Hence, the fixture device may be moved in relation to the support, for example, over a surface of the support. In other words, this may provide for the fixture device to be slidable and/or movable over the surface of the support while continuously attracting the support by the magnet in the socket, proving in the facilitated holding and/or fixation of components in a desired position and/or orientation.

According to an embodiment, the magnet may comprise a permanent magnet and wherein the ball may comprise a ferromagnetic material.

This may further facilitate selecting a desired orientation of the fixture device by providing a magnetic force acting on the ferromagnetic ball.

According to an embodiment, the socket may be at least partly enclosing the ball.

By the socket at least partly enclosing the ball a facilitated reception of the ball by the socket may be achieved.

According to an embodiment, the socket may comprise a friction member.

The friction member may further facilitate selecting a desired orientation of the fixture device by increasing the friction between the ball and the socket. This may facilitate keeping the desired orientation of the ball and thus the holding device. Further, the friction member may provide in less wear on the ball and/or socket since the friction member may absorb at least some of the friction force from the ball and/or socket.

According to an embodiment, the first holding element may comprise a first contact surface and the second holding element may comprise a second contact surface and wherein said holding device may be arranged to move between an open position and the holding position and wherein the first and second contact surfaces may be arranged parallel to each other when the holding device is moving between the open position and the holding position.

By the holding device moving between the open position and the holding position it may be meant that at least one of the first and second holding elements are moved such that the holding device is moved between the open position and the holding position.

By the first and second contact surfaces may be arranged parallel to each other when the holding device is moving between the open position and the holding position may provide for contact surfaces of the holding device to be substantially parallel throughout the movement from an open position to a closed position, i.e. from the open position to the holding position. This may provide for facilitated holding properties of the holding device by providing that the pressure applied by the holding elements may not be dependent on the distance from for example a rotational centre of openable jaws, as may be the case for, for example, jaws in a typical clip. In other words, in a typical clip, such as crocodile clip, the clip may rely on biased, openable jaws wherein the jaws rotate about a common axis of rotation of the clip in order to hold a device. The force applied to a component being held by the typical clip may therefore be dependent on the distance from the common axis of rotation of the clip to the point of contact to the component on the clip. Hence, by the first and second contact surfaces being arranged parallel to each other, this may provide for facilitated holding properties of the holding device. Also, the parallel contact surfaces may provide for a facilitated holding property of the holding device by the surfaces being parallel throughout the movement of the holding device between the open and the closed position, providing in an parallel contact surface to the direction of movement of the first and/or the second holding element when the holding device is moving between the open position and the holding position, which in turn may provide for a parallel contact surface to components arranged in between the first and second holding element of the holding device under operation of the holding device. The first and second holding element may be substantially parallel regardless of the degree of how much the holding device is opened, i.e. the distance between the first and second holding element.

According to an embodiment, the fixture device may be arranged for being in a tilted position and wherein the holding device may comprise a protruding member for being in contact with the support and for aligning the fixture device with the support when in said tilted position.

By a tilted position it may be meant a position wherein the fixture device is tilted. In other words, at least part of the fixture device may be arranged substantially parallel with the support. In yet other words, there may be a normal position wherein the fixture device extends substantially perpendicular from to at least part of the socket and wherein the tilted position is a position wherein the fixture device is arranged substantially perpendicular to the normal position.

By aligning the fixture device with the support, it may be meant assisting orientation of the fixture device in relation to the support. It may be meant assisting orientation of at least part of the fixture device into a predetermined position in relation to the support. Hence, by a protruding member for aligning the fixture device with the support when in said tilted position, it may be meant that the fixture device may be aligned in a predetermined position in relation to the support using the protruding member when the fixture device is in said tilted position.

The protruding member may provide for a facilitated positioning of the fixture device in relation to for example a support.

According to an embodiment, at least part of the holding device may comprise a ferromagnetic material such that the magnet in the socket may magnetize at least part of the holding device and the protruding member of the holding device such that the holding device may be intended to be removably attached to the support by the magnet when the fixture device is in said tilted position.

By the holding device may be intended to be removably attached to the support by the magnet, it may be meant that at least part of the holding device may be attached to the support by a magnetic force from the magnet by the magnet magnetizing at least part of the holding device.

By at least part of the holding device may comprise a ferromagnetic material may provide for the socket to magnetize the holding device and the protruding member such that a facilitated alignment of the holding device may be achieved by the protruding member being removably attached to the support.

According to an embodiment, the holding device may comprise a top section comprising a ferromagnetic material and may be arranged to be received by the socket, and wherein the socket may further be arranged to receive the top section by the magnet.

This may further facilitate the holding and/or fixation of components in a desired position and/or orientation since this may provide for additional positions and/or orientations available for the holding device. This may also provide for the first and/or second holding element to be arranged closer to the socket and/or the support when the fixture device is in use.

According to an embodiment, the holding device may comprise a rod connecting the ball and at least one of the first and second holding elements of the holding device, wherein at least part of said biasing member is arranged encircling at least part of the rod.

By a rod it may be meant a rod with any cross-sectional shape. The cross-sectional shape may be round, squared, rectangular, triangular or a cross-sectional shape with any number of corners.

By the biasing member is arranged encircling at least part of the rod it may be meant that at least part of the biasing member is arranged enclosing at least part of the rod. By the biasing member is arranged encircling at least part of the rod it may be meant that the biasing member is arranged around at least part of the rod.

By the biasing member encircling at least part of the rod a facilitated biasing of the holding member may be provided. In other words, this may facilitate creating a built-in in mechanical force, forcing the two holding elements together. Wherein the built-in mechanical force may act on at least one of the first and second holding elements. By encircling the biasing member around the rod this may provide for biasing of at least one of the two holding members in a space efficient manner.

The rod may provide for an increased reach of the holding device by proving an increased extension of the holding device from the ball. The rod may also provide for guidance of the biasing member.

According to an embodiment, the socket may comprise a first section and a second section, wherein the first section may comprise the magnet and the second section may be arranged to at least partly enclose the ball.

This may provide for a facilitated manufacturing process of the socket since shaping the magnet into its desired form may be a complex process. Hence, by instead shaping the ferromagnetic material, the magnet may be left as is and the magnet may create a magnetic field affecting the ferromagnetic material providing a facilitated manufacturing process of the socket. In other words, the manufacturing of the socket may be facilitated since the ferromagnetic material may be more easily shaped than the magnetic material of the magnet. Additionally, the magnetic properties of the socket, such as for example the magnetic force acting on the ball from the ferromagnetic material, may be adapted and/or varied depending on the ferromagnetic material used. As a non-limiting example, the ferromagnetic material may be chosen dependent on its material characteristic and/or the ferromagnetic material may comprise an alloy, wherein at least one material may be a ferromagnetic material and the other material may be adapted such that a desired magnetic property of the socket is achieved.

According to an embodiment, the socket may comprise a spacer for creating a distance between the socket and the support when said socket is fastened to said support.

By creating the socket comprising a spacer this may facilitate adapting the magnetic force of which the socket may be exerting on for example a support or any other surface of which the socket may be attached to. Additionally, this may provide in less friction between the socket and the support or any other surface of which the socket may be attached to. Further, this may provide in less wear of at least one of the socket, at least part of the socket, and the support and/or any other surface of which the socket may be attached to.

According to an embodiment, the support may comprise a ferromagnetic material.

According to an embodiment the arrangement comprise more than one fixture device arranged on the surface of the support, wherein each one of the more than one fixture device (100) is configured to hold at least one component.

This may provide for a relatively strong attraction between the magnet and the support in comparison to other magnetic materials, such as for example using a ferrimagnetic material.

It is noted that embodiments of the invention relates to all possible combinations of features recited in the claims.

### BRIEF DESCRIPTION OF THE DRAWINGS

This and other aspects will now be described in more detail in the following illustrative and non-limiting detailed description of embodiments, with reference to the appended drawings.

FIG. 1 shows a side view of the holding device according to an embodiment.

FIGS. 2a and 2b show a perspective and a side view respectively, of the fixture device according to an embodiment.

FIGS. 3a and 3b show a perspective and a side view respectively, of the fixture device according to an embodiment.

FIG. 4 shows a side view of the fixture device according to an embodiment.

FIGS. 5a and 5b show a perspective and a sectional side view respectively, of the fixture device according to an embodiment.

FIGS. 5c and 5d show a perspective and a sectional side view respectively, of the fixture device according to an embodiment.

FIGS. 6a and 6b show perspective views of the fixture device according to at least one embodiment.

FIG. 7 shows a perspective view of two fixture devices according to at least one embodiment.

FIG. 8a show a side view of the fixture device being attached to a support according an embodiment.

FIG. 8b show a side view of the fixture device being attached to a support according an embodiment.

FIG. 9 shows a perspective view of two fixture devices being attached to a support according an embodiment.

All the figures are schematic, not necessarily to scale, and generally only show parts which are necessary in order to elucidate the embodiments, wherein other parts may be omitted. Like reference numerals refer to like elements throughout the description.

### DETAILED DESCRIPTION OF EMBODIMENTS

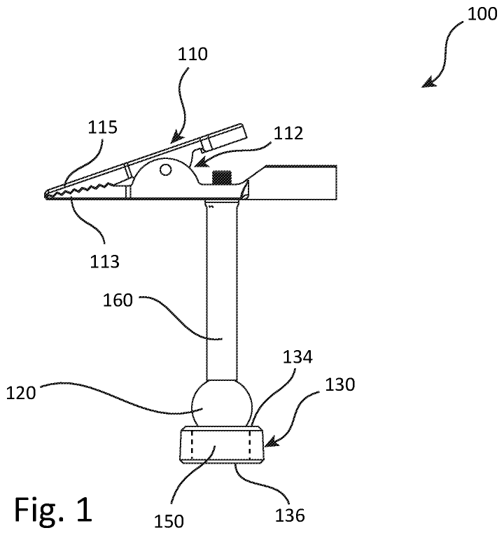

A fixture device 100 according to an embodiment will be described with reference to FIG. 1. The fixture device 100 in FIG. 1 comprises a holding device 110 intended to removably holding components. The holding device 110 comprising a first holding element 113, a second holding element 115 and a biasing member 112. The biasing member 112 may be arranged to force the two holding elements into a holding position. The fixture device 100 in FIG. 1 further comprises a ball 120 attached to the holding device 110 and a socket 130. The socket 130 may comprise a magnet 150. The socket 130 may further comprise a first side 134 configured to receive at least part of the ball 120 such that the ball 120 can slide in relation to the socket 130 and a second side 136 intended for fastening the fixture device to a support by the magnet 150. At least a section of the ball 120 may be made of a magnetic material such that the ball 120 may be maintained in a selected position in relation to the socket by the magnet 150.

The ball 120 may move freely within the socket 130. In other words, the ball 120 may move freely within the socket 130 according to a three axis articulation. In yet other words, the ball 120 may swivel within the socket 130. The movement of the ball within the socket 130 may be limited based on the position of the holding device 110 and/or any part connecting the holding device 110 to the ball 120. The holding device may comprise a rod 160 or a connecting device suitable to connect the holding device 110 and the ball 120, wherein the rod 160 and/or the connecting device may be arranged to connect the ball and at least one of the first and second holding elements 113, 115 of the holding device 110. In other words, the holding device 110 may comprise the rod 160 connecting the ball 120 to at least one of the first and second holding elements 113,115 of the holding device 110. In other words, the holding device 110 may be connected to the ball 120 by a rod 160 or any connecting device suitable to connect the holding device 110 and the ball 120. The movement of the ball may, for example, be limited by the position of the rod 160 onto the ball 120. The magnet 150 may comprise a permanent magnet and the ball 120 may comprise a ferromagnetic material that may provide in a strong reception or attachment of the ball to the socket 130.

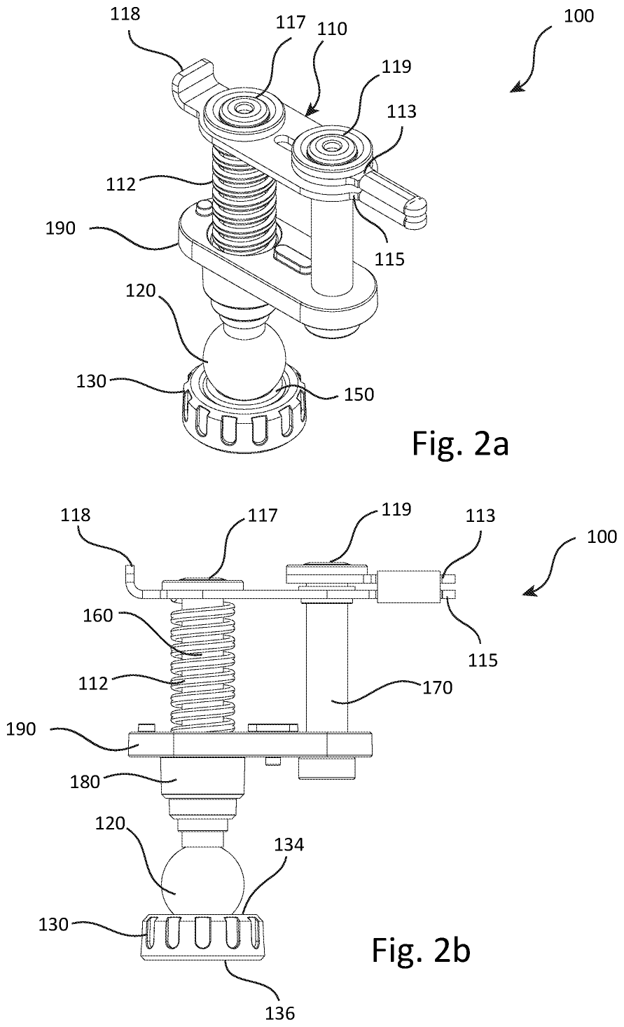

The fixture device 100 according to an embodiment will be described with reference to FIGS. 2a and 2b. Similar to the fixture device 100 in FIG. 1, the fixture device 100 in FIGS. 2a and 2b may comprise a holding device 110 intended to removably hold components. The holding device 110 may comprise a first holding element 113, a second holding element 115 and a biasing member 112. The biasing member 112 may be arranged to force at least one of the two holding elements into a holding position. The fixture device 100 in FIGS. 2a and 2b further comprises a ball 120 attached to the holding device 110 and a socket 130. The socket 130 may comprise a magnet 150. The socket 130 may further comprise a first side 134 configured to receive at least part of the ball 120 such that the ball 120 can slide in relation to the socket 130 and a second side 136 intended for fastening the fixture device to a support by the magnet 150. At least a section of the ball 120 may be made of a magnetic material such that the ball 120 may be maintained in a selected position in relation to the socket by the magnet 150.

The first and the second holding element 113,115 of the fixture device in FIGS. 2a and 2b are parallel and the fixture device 100 is arranged in a holding position. The holding position may be a position wherein the first and the second holding element 113,115 are brought into contact with each other, such as seen in FIGS. 2a and 2b, and/or when the first and second holding element 113,115 are brought into contact with an item being held in place by said holding device 110. Hence, the holding position may be equivalent to a closed position of said holding device 110 when no component is being held by the holding device 110 or an at least partly open position. By an at least partly open position it may be meant a position of the holding elements 113,115 wherein the two holding elements 113,115 are kept apart by an item held by said holding device 110.

By an item it may be meant a component held in place by the fixture device 100 or parts thereof, such as the holding device 110. By an item it may be meant a component held in place by the first and second holding elements 113,115.

In other words, the holding position may be a position wherein the two holding elements 113,115 are be brought into contact with each other by force from the biasing member 112 as also seen in FIGS. 2a and 2b. The holding position may also be a position wherein the two holding elements 113,115 are brought into contact with an item held by the holding device by force from the biasing member 112.

By the holding position it may be meant that the holding device 110 is in equilibrium without any external forces applied. By no external forces it may be meant that only forces from the biasing member 112 may be present. By no external forces it may be meant that only forces from the biasing member 112 and forces from any item held by the holding device 110 may be present. To further clarify, by no external force it may be meant that no forces acting on the holding device to pry the holding device 110 apart such that at least one of a contact between the first and second holding element 113,115, a contact between the first holding element 113 and an item held by the holding device 110, and a contact between the second holding element 115 and an item held by the holding device 110. In other words, the sum of forces acting on the first holding element 113 and the second holding element 115 may be zero without any external forces applied to the device. In other words, the force(s) acting on the first holding element 113 and/or the second holding element 115 by the biasing member 112 may be cancelled by forces of same amount but in opposite direction acting on the first holding element 113 and the second holding element 115 from for example, any component held in between the holding device 110 when the fixture device 100 is in said holding position.

The holding device 110 in FIGS. 2a and 2b may comprise the rod 160 or a connecting device suitable to connect the holding device 110 and the ball 120. The rod 160 and/or the connecting device may be arranged to connect the ball and at least one of the first and second holding elements 113, 115 of the holding device 110. In other words, the holding device 110 may comprise the rod 160 connecting the ball 120 to at least one of the first and second holding elements 113,115 of the holding device 110. In other words, the holding device 110 may be connected to the ball 120 by a rod 160 or any connecting device suitable to connect the holding device 110 and the ball 120. The movement of the ball may, for example, be limited by the position of the rod 160 onto the ball 120. The magnet 150 may comprise a permanent magnet and the ball 120 may comprise a ferromagnetic material that may provide in a strong reception or attachment of the ball to the socket 130.

The second rod 170 may comprise for example steel, stainless steel or titanium. The material of the second holding element 115 may be of the same or different material than the material of the second rod 170. Preferably, the material of the second holding element 115 may be of a softer material than the material of the bent member 175. Hence, the material of the second holding element 115 may comprise for example steel, stainless steel, brass, copper, or a hard plastic material such as acrylic, PVC, polythene and/or polypropylene.

The biasing member 112 may be acting on at least one of the first holding element 113 and the second holding element 115. By the biasing member acting on at least one of the first holding element 113 and the second holding element 115 it may be meant that the biasing member biases at least one of the first holding element 113 and the second holding element 115. The biasing member 112 may be at least one of a helical spring, a coil spring, a torsion spring, a helical torsion spring, a mainspring and any other biasing member arranged to store mechanical energy. As seen in FIGS. 2a and 2b the biasing member 112 may be a coil spring and/or a helical spring. At least part of the biasing member 112 may be arranged encircling at least part of the holding device 110. At least part of the biasing member 112 may be arranged encircling at least part of the rod 160. As seen in FIGS. 2a and 2b, the coil spring and/or helical spring may be arranged encircling the rod 160 biasing the first holding element 113 and/or the second holding element 115 such that the holding device 110 is arranged in the holding position.

The socket 130 may be at least partly enclosing the ball 120. The ball 120 may move freely within the socket 130. In other words, the ball 120 may move freely within the socket 130 according to a three axis articulation. In yet other words, the ball 120 may swivel within the socket 130. The movement of the ball within the socket 130 may be limited based on the position of the holding device 110 and/or any part connecting the holding device 110 to the ball 120. For example, the movement of the ball 120 within the socket 120 may be limited by the position of the rod 160 onto the ball 120. The magnet 150 may comprise a permanent magnet and the ball 120 may comprise a ferromagnetic material that may provide in a strong reception or and/or attachment of the ball 120 to the socket 130 by the magnet 150. In other words, a strong magnetic force between the ball and the socket may be achieved.

The socket 130 may at least partly enclose the ball 120. As seen in FIGS. 2a and 2b the ball 120 may be received by the socket 130 such that the socket 130 at least partly encloses the ball 120. In other words, the ball 120 may be arranged such that it is at least partly arranged within the socket 130.

As previously disclosed at least a section of the ball 120 may be made of a magnetic material such that the ball 120 may be maintained in the selected position in relation to the socket by the magnet 150. Hence, a position of the ball 120 and/or the holding device 110 in relation to the socket may be selected. The ball 120 may as previously disclosed be moving freely within the socket 130. Hence, the ball 120 and the holding device 110 may be rotated in any direction. The ball 120 and the holding device 110 may be tilted in any direction by the ball 120 rotating within the socket 130. In other words, any position of the ball 120 within the socket 130 may be selected. Hence, any position of the ball 120 and the holding device 110 in relation to the socket 130 may be selected.

The rod 160 may be elongated in a direction pointing away from the socket 130. The direction of the rod 160 in relation to the socket 130 may further be adjustable as described above. The holding device 110 may further comprise a protruding member 118. The protruding member 118 may be arranged such that a distance from the outer end of the protruding member and a center of the rod 160 is substantially the same as a distance between the center of the ball 120 to the second side 136 of the socket. By an outer end of the protruding member 118 it may be meant the part of the protruding member arranged furthest away from the center of the rod 160.

The socket 130 may be arranged for being attached to a support. The second side 136 of the socket may be arranged for attachment to the support. The protruding member 118 may be protruding in a direction perpendicular to the elongation of the rod 160. A previously disclosed any position of the ball 120 and the holding device 110 in relation to the socket 130 may be selected. Hence, a tilted position may be selected. Hence, the fixture device 100 may be arranged for being in a tilted position and the protruding member 118 may be arranged for being in contact with the support and for aligning the fixture device with the support when in said tilted position. Consequently, the protruding member 118 may facilitate aligning the fixture device 100 in a position where at least part of the fixture device 100 may be parallel to the first 134 and/or second side 136 of the socket 130. In other words, the protruding member 118 may be arranged for facilitating alignment of the fixture device 100 in a position where at least part of the fixture device 100 may be parallel to the support. The protruding member 118 may facilitate alignment of the fixture device 100 such that the rod 160 is arranged parallel to the first 134 and/or second side 136 of the socket 130. Hence, the protruding member 118 may be arranged for aligning the fixture device such that the rod 160 is arranged parallel to the support. When the fixture device is attached to a surface and/or support the protruding member 118 may facilitate alignment of the fixture device 100 such that the first and second holding elements 113,115 are directed parallel to a normal to the surface and/or support. The first and second holding elements 113,115 may be elongated and extend in a direction perpendicular to the elongation of the rod 160.

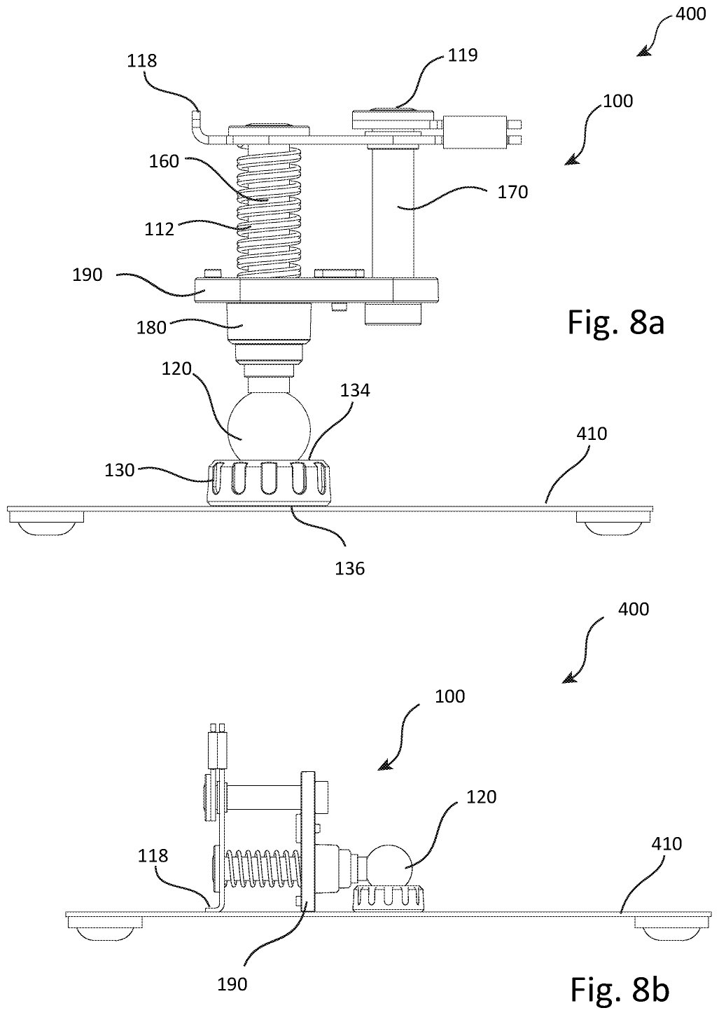

The holding device 110 may comprise a ferromagnetic material such that the magnet 150 in the socket 130 magnetizes the holding device 110 and the protruding member 118 of the holding device 110 by the magnet such that the holding device 110 may be intended to be removably attached to the support when in said tilted position. The rod 160 may comprise a magnetic material, for example a ferromagnetic material, such that the magnet 150 in the socket 130 magnetizes the holding device 110 or parts thereof. The rod 160 may comprise a magnetic material such that the magnet 150 in the socket 130 magnetizes the protruding member 118. The second holding element 115 may comprise the protruding member 118. Hence, at least part of the holding device may comprise a magnetic material, such as a ferromagnetic material. This may facilitate the magnetization of the protruding member 118, with in turn may provide a facilitated alignment of the fixture device 100 when in use together with a support. This is further discussed in relation to FIG. 8b.

The fixture device 100 may comprise a strut member 190. The fixture device may further comprise a biasing holder 180. The biasing holder 180 may be connected to the strut member 190. The biasing holder 180 may facilitate biasing of the biasing member 112. The biasing holder 180 may facilitate the compression of a helical spring and/or coil spring in FIGS. 2a and 2b.

The fixture device 100 may comprise a second rod 170. The rod 160 may be connected with the second rod 170 by the strut member 190. The rod 160 may be slidably connected to the strut member 190. The second rod 170 may be fixably connected to the strut member 190. The first holding element 113 may be connected to the second rod 170. The first holding element 113 may be fixably connected to the second rod 170. The second holding element may be fixably connected to the rod 160. The second rod 170 may be slidably connected to the second holding element 115. The biasing member 112 may act on the first and/or the second holding element 113,115. In other words, the biasing member 112 may bias the first and/or the second holding element 113,115. As seen in FIG. 2b, the biasing member 112 biases the first holding element 113 by forcing the strut member 190 towards the ball 120 such that the first holding element 113 is brought into contact with the second holding element 115. The second holding element 115 may comprise a through hole and the second rod 170 may be slidably connected to the through hole of the second holding element 115.

By slidably connected it may be meant that two components are connected and may slide in relation to one another. In other words, it may be meant that two components are connected and that the one of the two components being slidably connected may slide, i.e. move, in relation to the other component.

By fixably connected it may be meant that two components are connected without being able move in relation to each other. In other words, it may be meant that the components are connected and fixed in relation to each other.

The rod 160 and/or the second rod 170 may be elongated and have any cross-sectional shape. For example, the rod 160 and the second rod 170 in FIG. 2a-2b are elongated and comprises a round cross-sectional shape. The rod 160 and/or the second rod 170 may have any cross-sectional shape, i.e. at least one of the rod 160 and the second rod 170 may comprise at least one of a triangular, a rectangular and a round cross-sectional shape and any cross sectional shape with more sides than that of an rectangle.

The rod 160 and the second rod 170 may be arranged parallel to each other. The rod 160 and the second rod 170 may provide for improved stability in the holding device 110.

The second rod 170 may comprise for example steel, stainless steel or titanium. The material of the second holding element 115 may be of the same or different material than the material of the second rod 170. Preferably, the material of the second holding element 115 may be of a softer material than the material of the second rod 170. Hence, the material of the second holding element 115 may comprise for example steel, brass, copper, or a hard plastic material such as acrylic, PVC, polythene and/or polypropylene. Further, the hard plastic material may preferably be conductive plastic material. The rod 160 and/or the first holding element 113 may comprise the same material as the second rod 170.

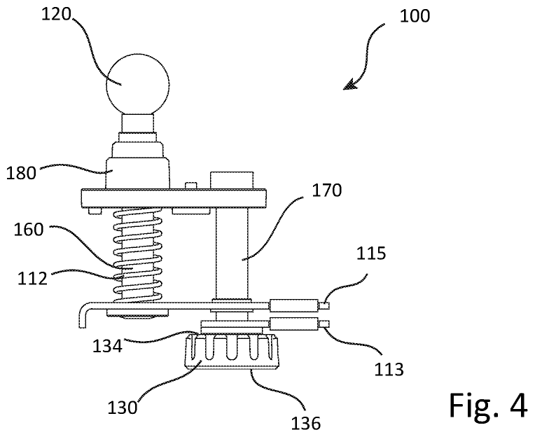

The fixture device 100 in FIGS. 2a and 2b may further comprise a top section 117, 119 comprising a ferromagnetic material and may be arranged to be received by the socket 130, and wherein the socket 130 may further be arranged to receive the top section 117, 119 by the magnet 150. Hence, the holding device 110 and the ball 120 may be removed from the socket 130 and reattached to the socket 130 by turning the holding device 110 and the ball 120 upside down such that the top section 117, 119 may be received by the socket. The fixture device 100 may comprise at least one top section 117, 119. The fixture device 100 in FIGS. 2a and 2b comprises two top sections 117,119. In other words, the fixture device 100 may comprise a first and a second top section 117,119. Hence, the top sections 117, 119 in FIGS. 2a and 2b may comprise a ferromagnetic material and may be arranged to be received by the socket 130 by the magnet 150. The socket 130 in FIGS. 2a and 2b may be arranged to receive at least one of the top sections 117,119. This will be further discussed with reference to FIG. 4.

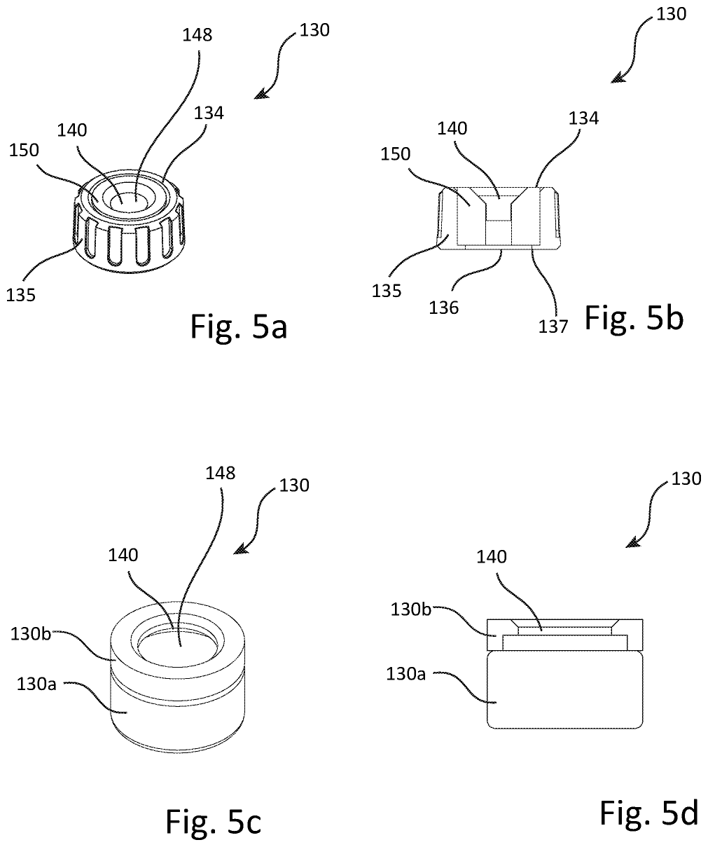

The fixture device 100 may preferably be grounded by connecting a grounded wire directly to the fixture device 100 and/or by grounding through the socket 130 which will be further discussed to FIGS. 5a-5c.

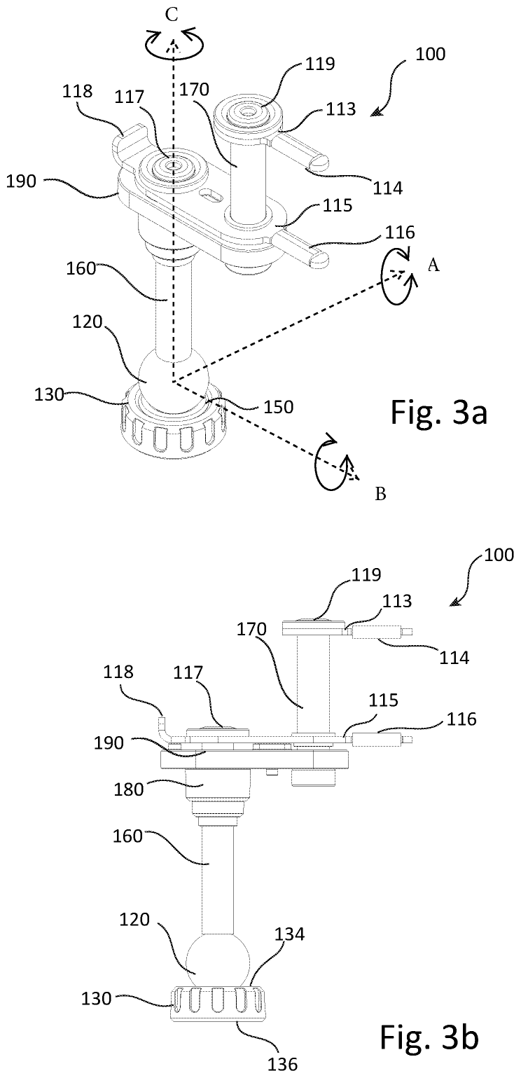

The fixture device 100 according to an embodiment will be described with reference to FIGS. 3a and 3b. The fixture device 100 in FIGS. 3a and 3b may be similarly configured as the fixture device 100 described with reference to FIGS. 2a and 2b, but the fixture device 100 in FIGS. 3a and 3b has the first holding element 113 and the second holding element 115 separated. This may illustrate that the fixture device 100 is arranged in the open position. The position of the first and second holding elements 113,115 in FIGS. 3a and 3b may be referred to a fully open position.

The first holding element 113 may comprise a first contact surface 114 and the second holding element 115 may comprise a second contact surface 116. The holding device 110 may be arranged to move between the open position and the holding position. The first and second contact surface 114, 116 may be arranged parallel to each other when the holding device is moving between the open position and the holding position.

Between the FIGS. 2(a & b) and 3(a & b), the strut member 190 and the first holding element 113 have been moved in relation to the rod 160 and the second holding element 115. Hence, moving the fixture device 100 from the holding position to the open position the strut member 190 may be moved in a direction towards the second holding element 115. The strut member 190 may be slidably connected to the rod 160 and may be arranged to move towards the second holding element 115 when the fixture device 100 is moved from the holding position to the open position.

The biasing member 112 may be biased by moving the strut member 190 towards the second holding element 115. The biasing member 112 may be arranged between strut member 190 and the second holding element 115. The biasing member 112 may be arranged between the biasing holder 180 and the second holding element 115. The biasing holder 180 may hold the biasing member when the biasing member is biased. In other words, the biasing holder 180 may hold the biasing member when the biasing member is compressed. The biasing holder 180 may at least partly enclose the biasing member 112. This may facilitate keeping the direction and orientation of the biasing member 112. The biasing holder 180 may be configured to provide a desired biasing of the biasing member 112.

At least one of the first and second holding elements 113,115 may be fixably arranged to the rod 160. At least one of the first holding element 113 and the strut member 190 may comprise a first through hole wherein the rod 160 may be configured to slide. The second holding element 115 may comprise a second through hole wherein the second rod 170 may be configured to slide. In FIGS. 3a and 3b, the strut member 190 comprises a first through hole wherein the rod 160 is arranged to slide and the second holding element 115 comprises a second through hole wherein the second rod 170 is arranged to slide. The first holding element 113 may be fixably arranged to the second rod 170 and the second rod 170 may be fixably arranged to the strut member 190. The first holding element 113, the second rod 170 and the strut member 190 may be arranged as a composite part forming the first holding element 113, hence, the first holding element 113 may comprise the first through hole. This may provide for a facilitated guidance of at least one of the first and second holding elements 113,115.

By fixably arranged it may be meant that two components are arranged to each other without being able move in relation to each other. In other words, it may be meant that the two components are connected to each other without being able to move in relation to each other. In yet other words, it may be meant that the components are connected and fixed in relation to each other.

As previously discussed, the fixture device 100 in FIGS. 3a and 3b is arranged in the open position. Any position of the first and second holding elements 113,115 between the open position of the fixture device 100 in FIGS. 3a and 3b and the holding position illustrated in FIGS. 2a and 2b may be a partly open position. As previously disclosed this partly open position may be a position wherein an item may be arranged between the first and second hold elements 113,115.

The configuration of the rod 160 and the second rod 170 according to the present disclosure may provide for an improved stability of the fixture device 100.

The rod 160 and the second rod 170 may be arranged parallel to each other and further facilitating the guidance of at least one of the first and second holding element. This may also provide in an improved stability of the device.

With reference to FIG. 3a the movement of the ball 120 in relation to the socket 130 may be further clarified. As previously disclosed, the ball 120 may be arranged to move freely within the socket 130. The ball 120 may move according to a 3-axis articulation. Hence, the ball 120 and the holding device 110 may change its position according to a 3-axis articulation.

By a 3-axis articulation it may be meant rotation about three axes' being perpendicular to each other. In other words, it may be meant that the ball 120 may be moved freely within the socket 130. This may be illustrated by FIG. 3a wherein three axes' (A, B, C) are arranged perpendicular to each other. Hence, a first axis A may be perpendicular to a second axis B and a third axis C. Additionally, the second axis B may be perpendicular to the third axis C. The ball 120 may be arranged to rotate about at least one of the first axis A, the second axis B and the third axis C. Hence, the ball 120 may move freely within the socket 130.

The fixture device 100 according to an embodiment will be described with reference to FIG. 4. The fixture device 100 in FIG. 4 may be similarly configured as the fixture device 100 described with reference to FIGS. 3a and 3b and FIGS. 2a and 2b, but the fixture device 100 in FIG. 4 is arranged with the top section 119 attached to the socket 130.

As previously disclosed, the holding device 110 may comprise a top section 117,119 comprising a ferromagnetic material. The top section 117,119 may be arranged to be received by the socket 130. In other words, the top section 117,119 may be arranged to be attached to the socket 130. The socket 130 may further be arranged to receive the top section 117, 119 by the magnet 150.

As mentioned to FIGS. 2a and 2b the top sections 117, 119 may comprise a ferromagnetic material and may be arranged to be received by the socket 130 by the magnet 150. The socket 130 in FIG. 4 may be arranged to receive at least one of the top sections 117,119.

In FIG. 4, the holding device 110 and the ball 120 may have been removed from the socket 130 and reattached to the socket 130 by turning the holding device 110 and the ball 120 upside down such that the top section 117, 119 is attached to the socket 130. More specifically, the holding device is attached to the socket by the first top section 119 in FIG. 4. This may facilitate position of the holding elements 113,115 at a shorter distance from the socket 130 than if the ball 120 would be attached to the socket 130. Hence, this may facilitate holding items by the holding device 110 at a shorter distance from the socket 130. In turn this may facilitate positioning items at a relatively short distance from a surface and/or support when the fixture device is attached to a surface and/or a support.

The holding device 110 may be attached to the socket 130 by the second top section 119. In other words, the second top section 119 may be configured to be received by the socket 130. This may further facilitate position of the holding elements 113,115 at an even shorter distance from the socket 130 than when attaching the first top section 117 to the socket 130. Hence, this may facilitate holding items by the holding device 110 at a shorter distance from the socket 130. In turn this may facilitate positioning items at a relatively short distance from a surface and/or support when the fixture device is attached to a surface and/or a support.

Hence, the first and second top section 117,119 may provide for facilitated position and/or orientation of the holding device 110 in relation to the socket 130.

The socket 130 according to an embodiment will be described with reference to FIGS. 5a and 5b. As seen in FIGS. 5a and 5b, the socket 130 may comprise the magnet 150. The socket 130 may comprise a socket housing 135. The socket may comprise a spacer 137 for creating a distance between the socket and the support when said socket is fastened to said support. Hence, the spacer 137 may be arranged on the second side 136 of the socket 130. The housing 135 may be interconnected to the spacer 137. The housing 135 and the spacer 137 may be formed in one piece. The socket 130 may comprise a friction member 140. The friction member 140 may comprise at least one of a polymer, rubber and any material suitable to create friction between at least part of the ball 120 and the socket 130. The friction member 140 may comprise a plastic material. The friction member 140 may provide in increased friction between the ball 120 and the socket 130 when the ball 120 is attached to the socket 130. The spacer 137 may be arranged to cover the second side 136 of the socket at least partially. Hence, the spacer 137 may fully cover the magnet 150 arranged in the socket or the spacer 137 may be circumferentially arranged on the second side 136 of the socket 130 such that a though hole is formed through the socket 130.

The socket 130 may comprise electrically conductive material. At least one of the friction member 140 and the housing 135 may thus comprise electrically conductive material, preferably an electrically conductive plastic. This may be advantageous when the socket is fastened to, i.e. arranged on, a support, the support may be grounded providing a grounded fixture device 100. This is beneficial when working with components sensitive to ESD and when these components are held by the fixture device 100.

The first side 134 of the socket 130 may comprise chamfered edges arranged in the center of the socket 130. By chamfered edges it may be meant beveled edges and/or sloping edges. The chamfered edges may form a recess 148 arranged substantially in the center of the socket 130. The recess 148 formed by the chamfered edges may be round and/or circular.

In other words, the socket 130 may comprise the recess 148 arranged in the center of the first side 134 of the socket 130. The recess 148 may be round and/or circular. The recess 148 may comprise at least one chamfered edge. The chamfered edge may be arranged around the recess 148. Hence, the recess 148 may comprise at least one circumferentially arranged chamfered edge.

The chamfered edges may be arranged to facilitate reception of the ball 120. The recess 148 may comprise the friction member 140. The chamfered edges may be interconnected to a through hole of the socket 130, wherein the through hole may be arranged in the center of the socket 130 proving a passage from the first side 134 to the second side 136.

The friction member 140 may be arranged within the chamfered edges. Hence, the friction member 140 may be arranged in the center of the socket 130. The friction member 140 may be arranged on at least part of the surface of the socket 130 on its first side 134. The friction member 140 may be arranged on at least part of the chamfered edges enclosing the recess 148.

The socket 130 according to an embodiment will be described with reference to FIGS. 5c and 5d. The socket 130 in FIGS. 5c and 5d may be similarly configured as the socket 130 described with reference to FIGS. 5a and 5b, but the socket 130 in FIGS. 5c and 5d comprises a first section 130a and a second section 130b, wherein the first section 130a comprises the magnet 150 and the second section 130b is arranged to at least partly enclose the ball 120. Hence, the second section 130b may comprise the first side 134 of the socket 130. The second section 130b may comprise circumferential chamfered edges arranged around in the center of the socket 130. By chamfered edges it may be meant beveled edges and/or sloping edges. The chamfered edges may form the recess 148 arranged substantially in the center of the socket 130. The chamfered edges may be arranged to facilitate reception of the ball 120. The recess 148 formed by the chamfered edges may be circular and/or round. The recess 148 may comprise the friction member 140. In other words, the friction member 140 may be arranged in said recess 148.

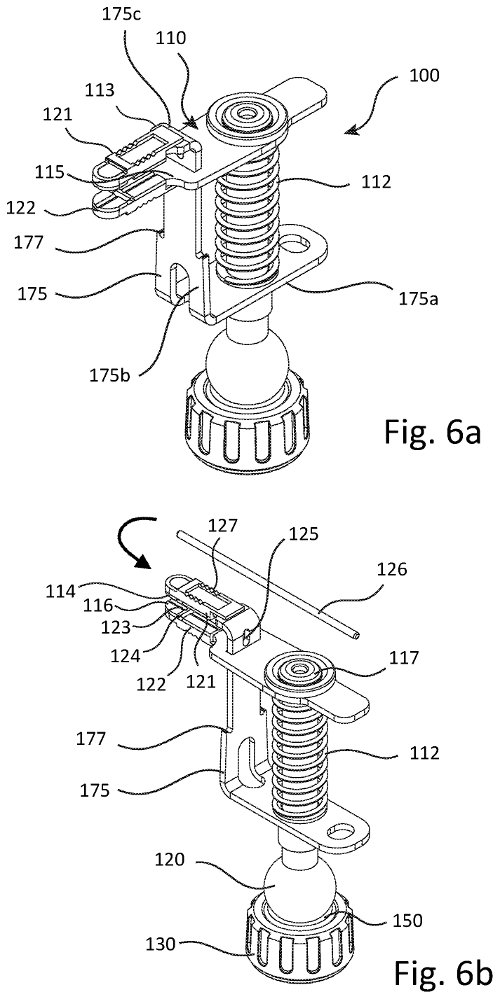

Turning to FIGS. 6a and 6b the fixture device 100 is further described. The fixture device 100 in FIGS. 6a and 6b may be identical to the fixture device 100 previously described to the FIGS. 2-4, except that the strut member 190, second rod 170, the first holding element 113 of the fixture device 100 in FIG. 6a is replaced by a bent member 175. The bent member may comprise three sections, a first section bent member section 175a, a second bent member section 175b and a third bent member section 175c wherein the first and third bent member sections 175a,175c are parallel to each other and the second bent member section 175b may be perpendicular to the first and third bent member sections 175a,175c. The third bent member section 175c may be arranged parallel to the rod 160.

The bent member 175 may be formed by an elongated sheet metal. The bent member 175 may be typically rigid to resist deformation from forces acting on the bent member 175 during use of the fixture device 100. The bent member 175 may comprise for example steel, stainless steel or titanium. The material of the second holding element 115 may be of the same or different material than the material of the bent member 175. Preferably, the material of the second holding element 115 may be of a softer material than the material of the bent member 175. Hence, the material of the second holding element may comprise for example steel, stainless steel, brass, copper, or a hard plastic material such as acrylic, PVC, polythene and/or polypropylene.

It should be understood that (only) the second rod 170 and at least one of the strut member 190 and the first holding element 113 may be replaced by the bent member 175. In other words, the strut member 190 and the second rod 170 may be replaced by the bent member 175 comprising the first and second bent member sections 175a,175b in connection with the first holding element 113. Alternatively, the first holding element 113 and the second rod 170 may be replaced by the bent member 175 comprising the second bent member section 175b and the third bent member section 175c connected to the strut member 190. By replacing at least one of the strut member 190 and the first holding element 113 together with the second rod 170 by the bent member 175 a facilitated manufacturing of the fixture device 100 may be achieved.

Accordingly, the fixture device 100 may comprise a bent member 175. The bent member 175 may comprise at least one bend, preferably 90 degrees, forming a L-shaped bent member comprising the second bent member section 175b and at least one of the first and third bent member sections 175a,175c. The bent member 175 may comprise two bends, both preferably 90 degrees, forming a Z-shaped bent member comprising the first, second and third bent member sections 175a,175b,175c.

The bent member 175 may form the first holding element 113. The first bent member section 175a may be slidably connected to the rod 160. The third bent member section 175c may form the first holding element 113. The second bent member section 175b may connect the first bent member section 175a to said third bent member section 175c or the first holding element 113. Alternatively, the second bent member section 175b may connect the strut member 190 to said third bent member section. The bent member 175 may comprise a through hole wherein the rod 160 may be configured to slide, identical to the strut member described to FIGS. 2-4. The through hole may be arranged in one end of the bent member 175.

In the same manner as the strut member 190 may be connected to a biasing holder 180 in FIG. 2a-2b, the bent member 175 may be connected to the biasing holder 180. The biasing member 112 may act on the second holding element 115 and the bent member 175. The biasing member 112 may force the bent member 175 towards the ball 120 such that the first holding element 113 are forced towards the second holding element 113.

As described to FIGS. 2a-2b, the second holding element 115 may comprise a through hole. The bent member 175 may be slidably connected to the through hole of the second holding element 115. The though hole of the second holding element 115 may have a corresponding shape as a cross-section of the bent member 175.

The bent member 175 may further comprise at least one abutment 177 for limiting the movement of the bent member 175 towards the second holding element 115. The at least one abutment 177 may be formed as a protrusion of the bent member 175 such that at least part of the bent member 175 may be too large to slide trough the through hole of the second holding element 115. The at least one abutment 177 may be arranged on the second bent member section 175b. By limiting the movement of the bent member 175 towards the second holding element 115 the force on the biasing member 112 may be reduced, further decreasing wear and tear of the biasing member 112 and thus proving increased life time of the biasing member 112.

Further, the protruding member 118 is not shown in FIGS. 6a and 6b, however it should be understood that the protruding member 118 as shown in FIGS. 2-4 may be present. Alternatively, the second holding element 115 may be arranged to contact with a support without having the protruding member 118 present when the fixture device 100 is arranged in the tilted position. Thus, an end part of the second holding element 115 may be arranged to contact with a support when the fixture device 100 is arranged in the tilted position.

The second bent member section 175b may comprise a bent member through hole 125. The bent member through hole 125 may be arranged to receive a bar 126. Further, the first and second holding elements 113,115 may both be provided with fixating elements 121,122 for facilitating fixation of components between the first and second holding elements 113,115. At least one of the fixating elements 121,122 may comprise an elongated first groove 123 for receiving said bar 126, further facilitating fixation and alignment of said bar 126 between the first and second holding elements 113,115. At least one of the fixating elements 121,122 may comprise a second elongated groove 124 for holding cables or similar in place when using said fixture device. The second elongated groove 124 may be arranged substantially perpendicular to the first elongated grove 123. The bar 126 may be used to force components in place when the fixture device 100 is equipped with the bar 126. This may typically be used when having more than one fixture device 100 arranged adjacent to each other where the fixture device 100 equipped with the bar 126 forces components in place held by a second fixture device 100. The bar 126 may be elongated have any cross-sectional shape, such as rectangular, squared, round or oval. Hence, the bar 126 may be formed as a rod or an elongated rectangular slab.

The fixating elements 121,122 may comprise a jagged surface structure 127 for facilitating holding components or similar between the first and second holding elements 113,115. In the Figure, the jagged surface structure 127 on the first holding element 113 is arranged facing away from the second contact surface 116 of the second holding element, 113. However, it should be understood that the fixating elements 121,122 of the first and/or the second holding element 113,115 may be arranged having the jagged surface structure 127 facing the contact surface of the opposite holding element. In other words, the contact surfaces 114,116 may comprise the jagged surface structure 127.

The fixating elements 121,122 may be removably attached to the respective first and second holding elements 113,115. The fixating elements 121,122 may be adjusted by turning them 180 degrees such that the contact surfaces 114,116 comprise either at least one of the first and second groove 123, 124 or the jagged surface structure 127. The fixating elements 121,122 may comprise a plastic material, preferably an electrically conducting plastic material. This facilitates working with components sensitive to ESD and when the fixture device 100 is grounded.

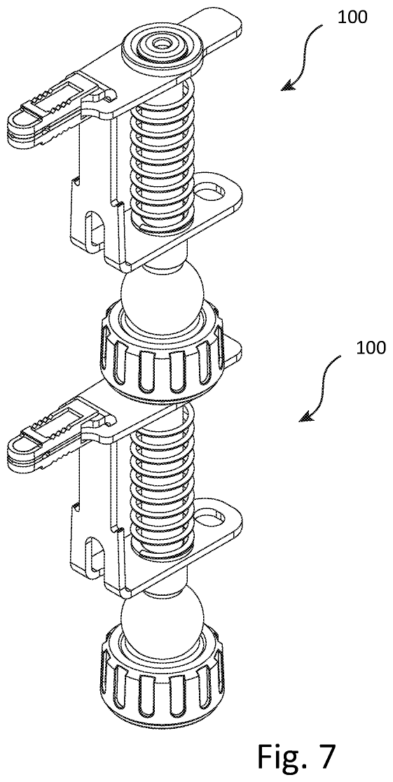

Turning to FIG. 7 which illustrates two fixture devices 100, e.g. an upper and a lower fixture device 100. Each one of the fixture devices 100 in FIG. 7 may be identical to the fixture device 100 according to anyone of the previous embodiments. One of the two fixture devices 100, e.g. the upper fixture device 100 is illustrated as being stacked on top of the other of the two fixture devices 100, e.g. the lower fixture device 100. In other words, the fixture device 100 may be stackable in order to facilitate working with device at different heights above a surface, such as a support, on which the lower fixture device 100 is attached. The upper fixture device 100 may be attached by a magnetic force onto the lower fixture device 100. In other words, the upper fixture device 100 may be magnetically attached to the lower fixture device 100. It should be understood that each one of the two fixture device 100 in FIG. 7 may be arranged in any position by having the ball 120 rotate in the socket 130 of the respective fixture device 100.

An arrangement 400 according to an embodiment will be described with reference to FIGS. 8a and 8b. The arrangement 400 may comprise at least one fixture device 100 according to any of the preceding embodiments. The arrangement 400 may further comprise a support 410. The support 410 may comprise a magnetic material. The at least one fixture device 100 may be arranged to be removably attached to the support 410 by a magnetic force.

The support 410 may comprise a ferromagnetic material. This may facilitate the attachment of the socket 130 to the support 410. The socket 130 may move in any direction parallel to the surface of the support 410. The socket 130 may be attached to the support 410 such that the socket 130 may be removably attached to the support 410. By applying a force at least partly directed in a direction parallel to the support 410, the socket 130 may be moved along the surface of the support 410. Hence, the socket 130 may be movable along the surface of the support 410. In other words, the fixture device 100 may be movably arranged on the surface of the support 410. By moving the socket 130 along the surface of the support 410 may provide adjustable positioning of the fixture device 100 along the surface of the support 410. As previously disclosed, the first side 134 of the socket 130 may be arranged to receive the ball 120. The second side 136 of the socket 130 may be arranged to be attached to the support 410. In other words, the socket 130 may be attached to the support 410 by the magnet 150. In other words, the socket 130 may be arranged to attach to the support by a magnetic force. Hence, the magnet 150 may be arranged to attract the socket 130 to the support 410 by a magnetic force.

As previously disclosed, the fixture device 100 may be arranged for being in a tilted position. In FIG. 8b an embodiment of the tilted position is illustrated, the holding device 110 and the ball 120 may be rotated such that the fixture device 100 is arranged in the tilted position. The holding device 110 may comprise the protruding member 118 for being in contact with the support and for aligning the fixture device with the support when in said tilted position. The strut member 190 may be arranged such that it is brought into contact with the support 410 while the protruding member 118 is brought in contact with the support 410. In other words, fixture device 100 may be arranged such that both the strut member 190 and the protruding member 118 may be in contact with the support 410 when the fixture device 100 is in said tilted position. The strut member 190 may comprise a magnetic material. The strut member 190 may comprise a ferromagnetic material.

As been discussed, the rod 160 may comprise a magnetic material, for example a ferromagnetic material, such that the magnet 150 in the socket 130 magnetizes the holding device 110 or parts thereof. When the rod 160 comprises a magnetic material, it may also provide magnetization of the strut member 190. The rod 160 may comprise a magnetic material, e.g. a ferromagnetic material, such that the magnet 150 in the socket 130 magnetizes at least one of the protruding member 118 and the strut member 190. The second holding element 115 may comprise the protruding member 118.

In other words, the fixture device 100 may comprise a magnetic material, e.g. a ferromagnetic material, such that the magnet 150 in the socket 130 magnetizes at least one of the holding device 110 and the strut member 190. This may facilitate attachment of the fixture device 100 to the support 410 when the fixture device 100 is in said tilted position since the holding device 110 may be intended to be removably attached to the support by at least one of the protruding member 118 and the strut member 190 when in said tilted position. By the fixture device comprising a magnetic material, such as a ferromagnetic material, a facilitated magnetization of the protruding member 118 and/or the strut member 190 may be provided. This may in turn provide a facilitated alignment of the fixture device 100 when in use together with the support 410. The support 410 may be grounded facilitating grounding of the fixture device 100 arranged on the support 410. The surface of the support 410 may be lacquered with an electrically conductive lacquer that may provide a desirable appearance of the support while maintaining the provided effect of grounding the fixture device 100.

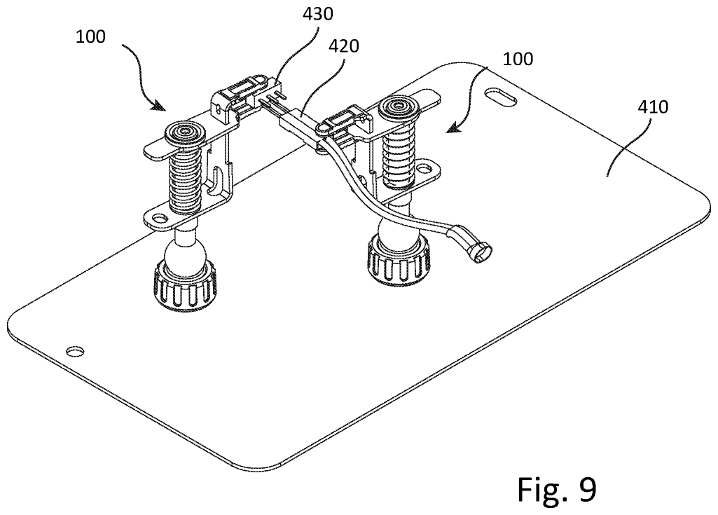

Turning to FIG. 9, which illustrates two fixture devices 100 arranged on the support 410. The support 410 may be identical to the support 410 discussed to FIG. 8. Further, the fixture devices 100 may be identical to any one of the previous embodiments of the fixture device 100, i.e. the fixture devices 100 in FIG. 9 may be identical to the fixture device 100 discussed to anyone of FIGS. 2-4, and 6. Further, in FIG. 9 a first and a second component 420,430 held by the more than one fixture device 100 is shown. Accordingly, there may be more than one fixture device 100, e.g. a first and a second fixture device 100, arranged on the surface of the support 410. Each one of the more than one fixture device 100 may be configured to hold at least one component 420,430. The more than one fixture device 100 may in combination be arranged to hold the at least one component 420,430. Hence, the more than one fixture device 100 may be configured to align two components, the first component 420 and the second component 430 such that the first and second components 420,430 are brought and held in contact with each other in order to facilitate working with the components, such as soldering of parts of the first component to parts of the second component. Further, as the fixture devices 100 are movably arranged on the surface of the support 410, the fixture devices 100 may be arranged on the support in a suitable manner for working with different types of components.

The person skilled in the art realizes that the present invention by no means is limited to the embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. For example, the description of the socket 130 in relation to FIGS. 5a-d may be applicable to the embodiments described to the other Figures. Analogously, the description of the fixture device 100 in FIGS. 1-4 and FIGS. 6a-6b and 7 may be applicable to FIGS. 8a-b and FIG. 9.

1. An arrangement comprising: a fixture device for removably holding components, said fixture device comprising; a holding device intended to removably holding components, said holding device comprising a first and a second holding element and a biasing member arranged to force at least one of the two holding elements into a holding position; a ball attached to the holding device; a socket comprising a first side configured to receive at least part of the ball such that the ball can slide in relation to the socket; and a magnet; wherein at least a section of the ball is made of a magnetic material such that the ball is maintained in a selected position in relation to the socket by the magnet, a support comprising a magnetic material wherein the fixture device is arranged to be removably attached to the support by a magnetic force and wherein the socket comprises a second side attached to the support by said magnet and wherein said socket is movable along the surface of the support.

2. The arrangement according to claim 1, wherein the magnet comprises a permanent magnet and wherein the ball comprises a ferromagnetic material.

3. The arrangement according to claim 1, wherein the socket is at least partly enclosing the ball.

4. The arrangement according to claim 1, wherein the socket comprises a friction member.

5. The arrangement according to claim 1, wherein the first holding element comprises a first contact surface and the second holding element comprises a second contact surface and wherein said holding device is arranged to move between an open position and the holding position and wherein the first and second contact surface are arranged parallel to each other when the holding device is moving between the open position and the holding position.

6. The arrangement according to claim 1, wherein the fixture device is arranged for being in a tilted position and wherein the holding device comprises a protruding member for being in contact with the support and for aligning the fixture device with the support when in said tilted position.

7. The arrangement according to claim 6, wherein at least part of the holding device comprises a ferromagnetic material such that the magnet in the socket magnetizes the holding device and the protruding member of the holding device such that the holding device is intended to be removably attached to the support by the magnet when the fixture device is in said tilted position.

8. The arrangement according to claim 1, wherein the holding device comprises a top section comprising a ferromagnetic material and arranged to be received by the socket, and wherein the socket is further arranged to receive the top section by the magnet.

9. The arrangement according to claim 1, wherein the holding device comprises a rod connecting the ball and at least one of the first and second holding elements of the holding device, wherein at least part of said biasing member is arranged encircling at least part of the rod.

10. The arrangement according to claim 1, wherein the socket comprises a first section and a second section, wherein the first section comprises the magnet and the second section is arranged to at least partly enclose the ball.

11. The arrangement according to claim 1, wherein the socket comprises a spacer for creating a distance between the socket and the support when said socket is fastened to said support.

12. The arrangement according to claim 1, wherein the support comprises a ferromagnetic material.

13. The arrangement according to claim 1 comprising more than one fixture device arranged on the surface of the support, wherein each one of the more than one fixture device is configured to hold at least one component.
